(19) United States
(12) Patent Application Publication
(10) Pub. No.: US 2012/0288113 A1
(43) Pub. Date: Nov. 15, 2012

(54) MICROPHONE

(76) Inventors: Hiroshi Akino, Kanagawa (JP); Shioto Okita, Kanagawa (JP)

(21) Appl. No.: 13/463,235

(22) Filed: May 3, 2012

(30) Foreign Application Priority Data
May 9, 2011 (JP) 2011-104014

(51) Int. Cl. H04R 1/00

(52) U.S. Cl. 381/92

(57) ABSTRACT

A microphone includes a plurality of microphone units; in which the microphone units include a first group of microphone units and a second group of microphone units, the first group of microphone units and the second group of microphone units are disposed alternately, the first group of microphone units are connected in series such that outputs from the first group of microphone units are added and outputted as an added output, the second group of microphone units are connected in series such that outputs from the second group of microphone units are added and outputted as another added output, and the added output of one of the first group of microphone units and the second group of microphone units is output from a hot terminal as a balanced output and the other added output is output from a cold terminal as a balanced output.

### BACKGROUND OF THE INVENTION

1. Technical Field

The present invention relates to a high-sensitivity microphone including a plurality of microphone unit.

2. Background Art

A microphone having a large-diameter diaphragm has high sensitivity and is capable of electroacoustic conversion in a low-tone range. In contrast, a microphone having a small-diameter diaphragm is capable of electroacoustic conversion in a high-tone range but has a low power level, i.e., has low sensitivity.

The inventors have proposed a microphone including a plurality of microphone units for increasing the sensitivity, the signal-to-noise (S/N) ratio, and the performance of the microphone. Specifically, such microphones are described in Japanese Unexamined Patent Applications Publication Nos. 2006-5710 and 2011-10046. Japanese Unexamined Patent Application Publication No. 2006-5710 describes a condenser microphone including a plurality of unidirectional condenser microphone capsules each having a diameter of 20 mm or smaller and an impedance converter, wherein the condenser microphone capsules are arranged such that the main axes of the condenser microphone capsules are parallel to each other and the diaphragms of the condenser microphone capsules reside on a single plane, and the condenser microphone capsules are connected to the impedance converter.

FIG. 5 illustrates a typical condenser microphone having a configuration based on substantially the same technological concept as that of the condenser microphone according to Japanese Unexamined Patent Application Publication No. 2006-5710. FIG. 5 illustrates a condenser microphone including five condenser microphone units 51 to 55. The condenser microphone units 51 to 55, respectively, include condenser microphone capsules 511 to 551 and impedance converters 512 to 552. Each capsule has a diaphragm that vibrates in response to received sound waves and a fixed electrode opposing the diaphragm, while each converter converts the impedance of the electroacoustic conversion output from the corresponding condenser microphone capsule to low impedance. The impedance converters 512 to 552 are auto-biased and each has a filed-effect transistor (FET), which is an active element. The drains of the FETs in the impedance converters 512 to 552 receive a direct voltage VCC from a voltage source, and the sources of the FETs are connected to a ground via respective resistors 513 to 553.

Circuits are configured such that electroacoustic conversion signals from the condenser microphone units 51 to 55 are output from the sources of the FETs via capacitors 514 to 554 and resistors 515 to 555, respectively, and are input to an inverting input terminal of an adder 60. The adder 60 adds the conversion output signals from the condenser microphone units 51 to 55 and outputs the resulting added signal as an output signal of the microphone. In FIG. 5, reference character P represents a sound source. Diaphragms of the condenser microphone capsules 511 to 551 reside on a single plane and are positioned such that the sound collecting axes are parallel to each other.

Japanese Unexamined Patent Application Publication No. 2011-10046 describes a condenser microphone including condenser microphone units having diaphragms disposed on a single plane, wherein the condenser microphone units are connected in series such that an output of an impedance converter connected one of the condenser microphone units drives the ground side of another condenser microphone unit.

In the condenser microphone according to Japanese Unexamined Patent Application Publication No. 2006-5710, microphone units that have a small distance between acoustic terminals and excellent directional frequency response in high frequencies are connected in parallel. This configuration can increase the effective capacitance and can reduce intrinsic noise while maintaining excellent directional frequency response. The condenser microphone according to Japanese Unexamined Patent Application Publication No. 2011-10046 includes a plurality of microphone units connected in series. Thus, the outputs of the microphone units are added to improve the sensitivity and the SN ratio.

Usually, microphones have a low power output and thus are easily affected by external electrical noise. Thus, it employs balanced transmission, which is insusceptible to electrical noise. Japanese Unexamined Patent Application Publication No. 2011-10046 describes a condenser microphone including four microphone units: two of the units being connected in series such that balanced transmission signals are output to the hot terminal, the other two units being connected in series with reversed polarity such that balanced transmission signals are output to the cold terminal.

Unfortunately, microphones having a plurality of microphone units, such as those described in Japanese Unexamined Patent Applications Publication Nos. 2006-5710 and 2011-10046, have the following problem. Since the diaphragms of the microphones are disposed on a single plane, no problem will occur if the distances from the diaphragms to the sound source are equal. If the distances from the diaphragms to the sound source differ from each other, sound waves from the sound source reach the acoustic terminals of the microphone units at different times. For example, if the sound source is positioned at a 90-degree angle to the sound collecting axes of the microphone units, sound waves from the sound source reach the acoustic terminals of the microphone units at different times. Accordingly, sound waves from a sound source that is not positioned at a 0-degree or a 180-degree angle to the sound collecting axes reach the acoustic terminals of the microphone units at different times. Hence, the waveform of a signal acquired by adding the signals output from the microphone units after converting the sound waves that have reached the microphone units at different times to electric signals differs from the waveform of the sound waves from the sound source, causing a difference in sound quality depending on the direction of the sound source.

When microphone units that output signals to the hot terminal and microphone units that output signals to the cold terminal are provided to perform balanced transmission, no problem will occur if the sound waves transmitted at a 90-degree angle to the sound collecting axes of the microphone units simultaneously reach the acoustic terminals of the microphone units. However, sound waves from a sound source not aligned with the sound collecting axes reach the acoustic terminals of the microphone units at different times. Such a time difference generates a sound pressure gradient, which corresponds to the time difference, across the diaphragms of the microphone units. As a result, the driving forces of the diaphragms depend on the frequency. Such frequency dependency causes a difference in sound quality.

FIGS. 6 and 7 each illustrate a difference between the case of no time difference and the case of any time difference. In FIGS. 6 and 7, reference numerals 61 and 71 represent microphone units. Output signals from the microphone unit 61 are transmitted via an impedance converter 62 and are output from the hot terminal as balanced output signals, and output signals from the microphone unit 71 are transmitted via an impedance converter 72 and are output from the cold terminal as balanced output signals. A sound source Po is equidistant from the diaphragms of the microphone unit 61 and 71, whereas a sound source Po′ is not equidistant from the diaphragms of the microphone unit 61 and 71. Since sound waves from the sound source Po reach the microphone units 61 and 71 at the same time, a difference in sound quality as described above does not occur. Since sound waves from the sound source Po′ reach the microphone units 61 and 71 at different times, the sound quality of the signals output to the hot terminal differs from that of signals output from the cold terminal due to frequency dependency.

FIG. 8 illustrates the directional frequency response characteristics of a conventional condenser microphone including a plurality of microphone units of which the outputs are added. FIG. 9 illustrates frequency characteristics of the microphone. The directional frequency response characteristics illustrated in FIG. 8 were measured at 1000 Hz, 2000 Hz, and 5000 Hz. The frequency characteristics illustrated in FIG. 9 were measured at an angle of the sound source of 0, 90, 180, and 270 degrees to the sound collecting axes.

Sound collection from a sound source on the sound collecting axes is important for musical-sound collecting microphones used in, for example, recording music. Sound waves from the sound source, however, do not necessarily directly reach a microphone but may be reflected by walls or other objects and enter the microphone at angles different from the angle of the sound collecting axes. For multiple sound sources over a wide area, for example, in a concert or a chorus, the microphone should have an excellent directional frequency response to sound waves coming from angles different from the sound collecting axes. Referring to FIG. 8, turbulence is observed particularly in directional frequency response in the high-pitch range which should be solved in musical-sound collecting microphones. Referring to FIG. 9, the frequency characteristics corresponding to sound waves coming from angles others than the sound collecting axes should be improved.

### SUMMARY OF THE INVENTION

An object of the present invention is to solve the problems in the conventional art described above, i.e., to provide a microphone that includes a plurality of microphones units whose outputs are added and performs balanced transmission by reducing the difference in sound qualities between signals output to the hot terminal and signals output to the cold terminal as a result of reductions in time difference between sound waves from a sound source aligned with and sound waves from a sound source not aligned with the sound collecting axes of the microphone units to reach the microphone units.

A microphone includes a plurality of microphone units; in which the microphone units include first group of microphone units and second group of microphone units, the first group of microphone units and the second group of microphone units are disposed alternately, the first group of microphone units are connected in series such that outputs from the first group of microphone units are added and outputted as an added output, the second group of microphone units are connected in series such that outputs from the second group of microphone units are added and outputted as another added output, and the added output of one of the first group of microphone units and the second group of microphone units is output from a hot terminal as a balanced output and the other added output is output from a cold terminal as a balanced output.

### BRIEF DESCRIPTION OF DRAWINGS

FIG. 1 is a model diagram schematically illustrating a microphone according to an embodiment of the present invention together with the circuitry thereof;

FIG. 2 is a model diagram schematically illustrating a microphone according to another embodiment of the present invention;

FIG. 3 is a circuit diagram illustrating exemplary connection of microphone units of the present invention;

FIG. 4 is a plan view of a typical arrangement of microphone units in a microphone according to the present invention;

FIG. 5 is a circuit diagram illustrating connection of microphone units in a typical conventional microphone;

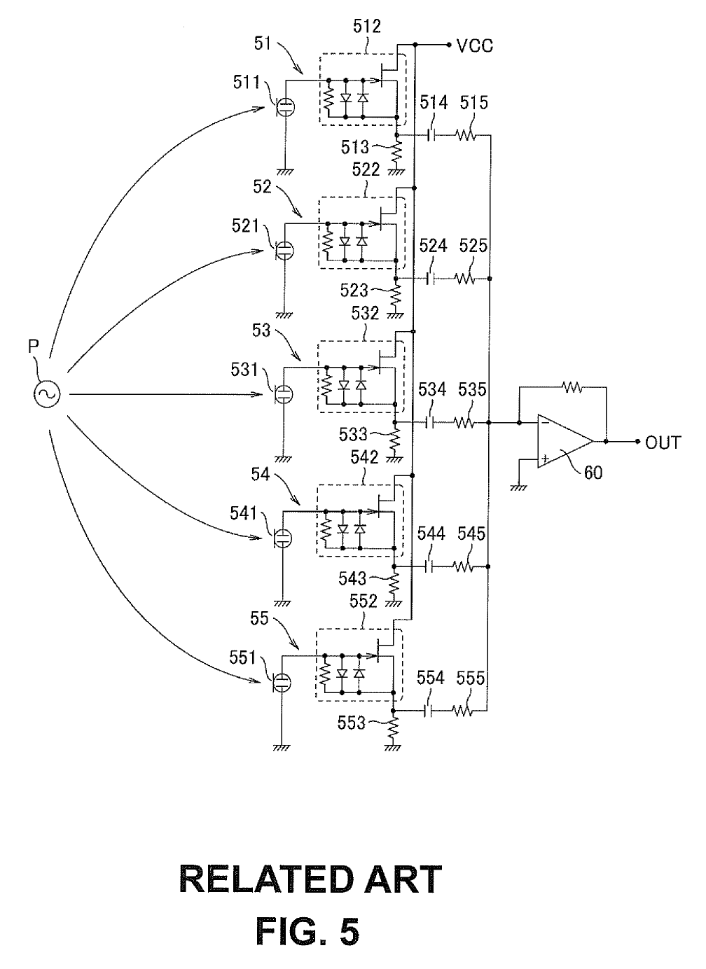

FIG. 6 is a model diagram of a conventional microphone including a plurality of microphone units viewed in the direction of the sound colleting axis;

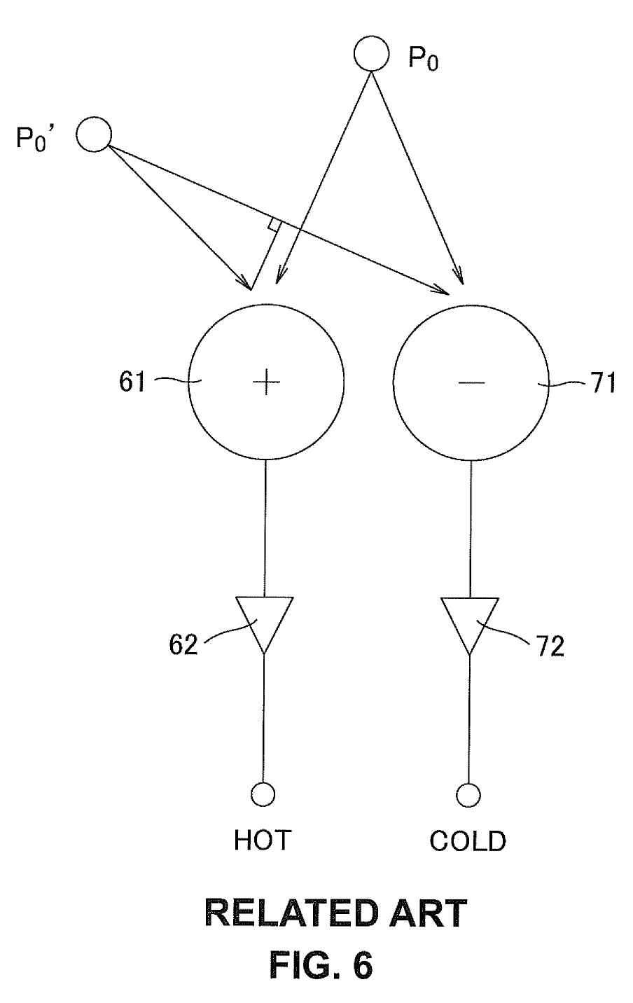

FIG. 7 is a model diagram of a conventional microphone viewed in the direction orthogonal to the sound colleting axes;

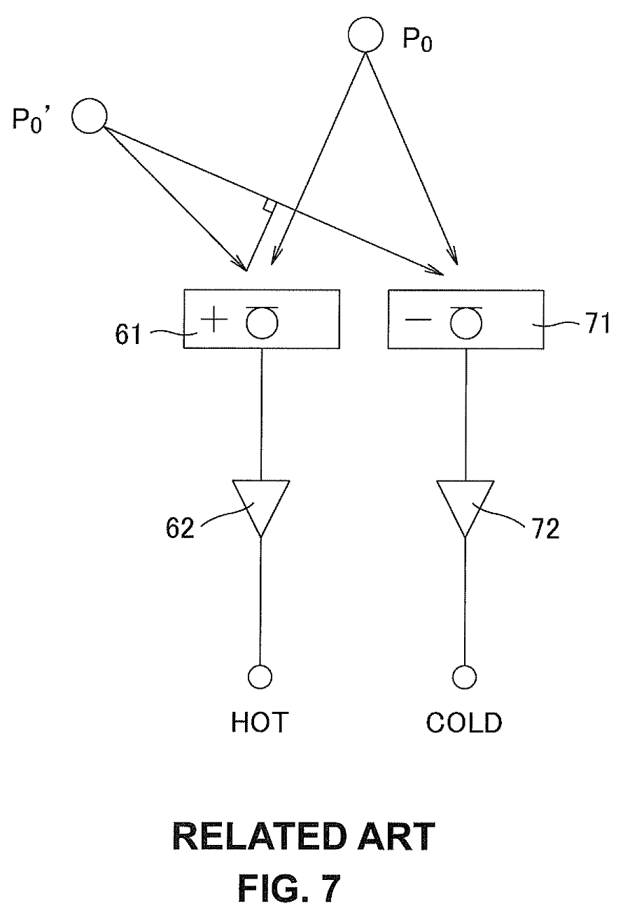

FIG. 8 is graph illustrating directional frequency response characteristics of a conventional microphone including a plurality of microphone units; and

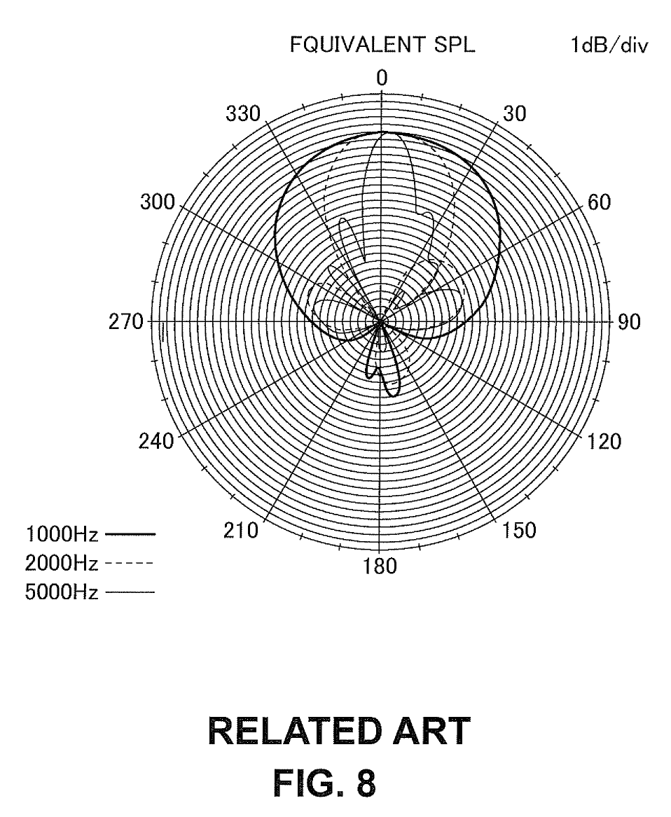

FIG. 9 is a graph illustrating frequency characteristics of a conventional microphone.

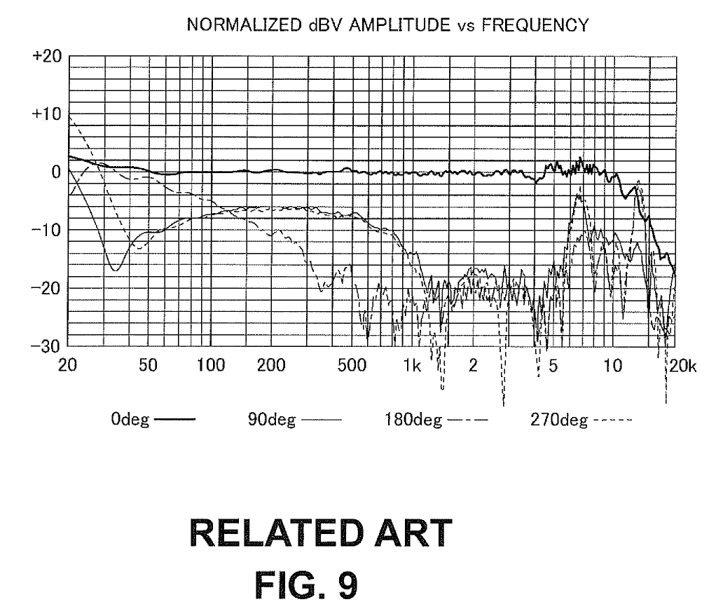

### DESCRIPTION OF THE PREFERRED EMBODIMENTS

A microphone according to an embodiment of the present invention will be described below with reference to the accompanying drawings.

### First Embodiment

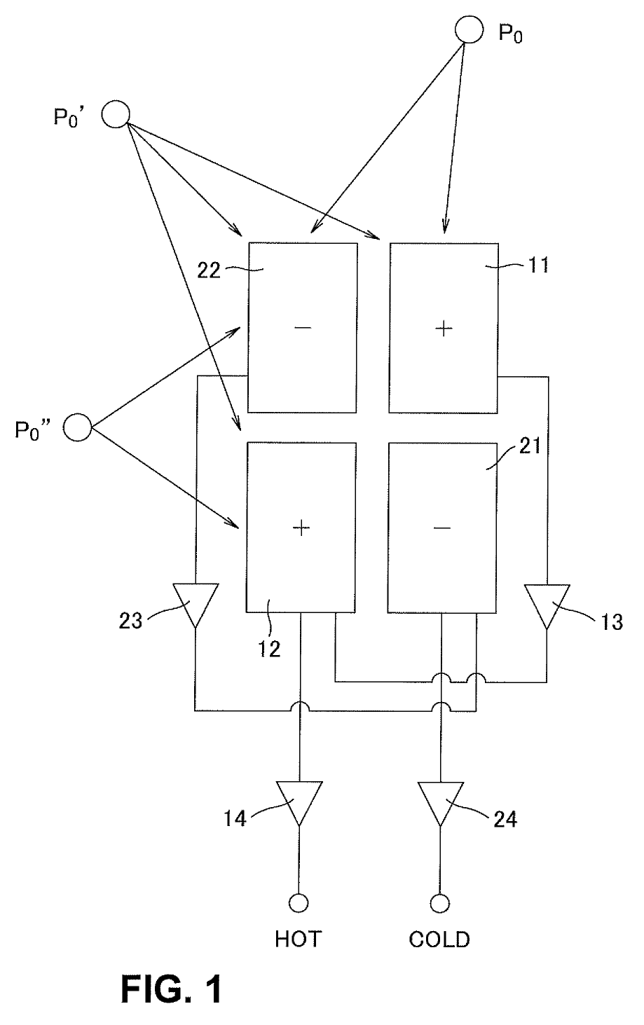

FIG. 1 illustrates a microphone according to a first embodiment of the present invention. In this embodiment, the microphone includes four microphone units 11, 21, 12, and 22. The directional axes of the microphone units 11, 21, 12, and 22 in FIG. 1 are orthogonal to the drawing. The directional axes of the microphone units 11, 21, 12, and 22 are parallel to each other. Thus, diaphragms in the microphone units 11, 21, 12, and 22 are parallel to the drawing and reside on a single plain.

The four microphone units 11, 21, 12, and 22 are categorized into a first group containing the microphone units 11, and 12 and a second group containing the microphone units 21 and 22. The four microphone units 11, 21, 12, and 22 are disposed, in this order, on a circle in view along the direction of the sound collecting axes. As a result, lines connecting the centers of the microphone units 11, 21, 12, and 22 define a square, in view along the direction of the sound collecting axes. The microphone units 11 and 12 in the first group are disposed at diagonal corners of the square, while the microphone units 21 and 22 in the second group are disposed at the other diagonal corners of the square. In other words, the microphone units 11 and 12 in the first group and the microphone units 21 and 22 in the second group are alternately disposed on the circle.

Any type of microphone units can be used in the microphone according to the present invention. The microphone units 11, 21, 12, and 22 according to this embodiment are condenser microphone units including condenser microphone capsules, each having a diaphragm vibrating in response to received sound waves and a fixed electrode opposing the diaphragm. The microphone units 11 and 12 in the first group include impedance converters 13 and 14, respectively, for impedance conversion of electrical signals output from the condenser microphone capsules of the microphone units 11 and 12 after electroacoustic conversion. The microphone units 21 and 22 in the second group include impedance converters 23 and 24, respectively, for impedance conversion of electrical signals output from the condenser microphone capsules of the microphone units 21 and 22 after electroacoustic conversion.

The condenser microphone units 11 and 12 in the first group are connected in series such that output signals from the microphone unit 11 are impedance-converted in the impedance converter 13 and drive the ground side of the condenser microphone capsule of the microphone unit 12. The circuitry is configured such that balanced transmission signals are output from the hot terminal via the impedance converter 14 of the microphone unit 12. Similarly, the condenser microphone units 22 and 21 in the second group are connected in series such that output signals from the microphone unit 22 are impedance-converted in the impedance converter 23 and drive the ground side of the condenser microphone capsule of the microphone unit 21. The condenser microphone units 22 and 21 in the second group are connected such that the polarity of the outputs from the condenser microphone units 22 and 21 is reversed to the polarity of the outputs from the condenser microphone units 11 and 12. The circuitry is configured such that balanced transmission signals are output from the cold terminal via the impedance converter 24 of the microphone unit 21.

In FIG. 1, reference characters Po, Po′, and Po″ represent sound sources. Even if sound waves from the sound sources Po, Po′, and Po″ reach the microphone units in the first and second groups at different times, the difference between the average time required for the sound waves to reach the first group of microphone units and the average time required for sound waves to reach the second group of microphone units is small because the first group of microphone units and the second group of microphone units are disposed alternately. Thus, the difference in sound quality between the signal output from the hot terminal, which is the sum of the outputs from the microphone units 11 and 12 in the first group, and the signal output from the cold terminal, which is the sum of the outputs from the microphone units 21 and 22 in the second group, can be decreased.

### Second Embodiment

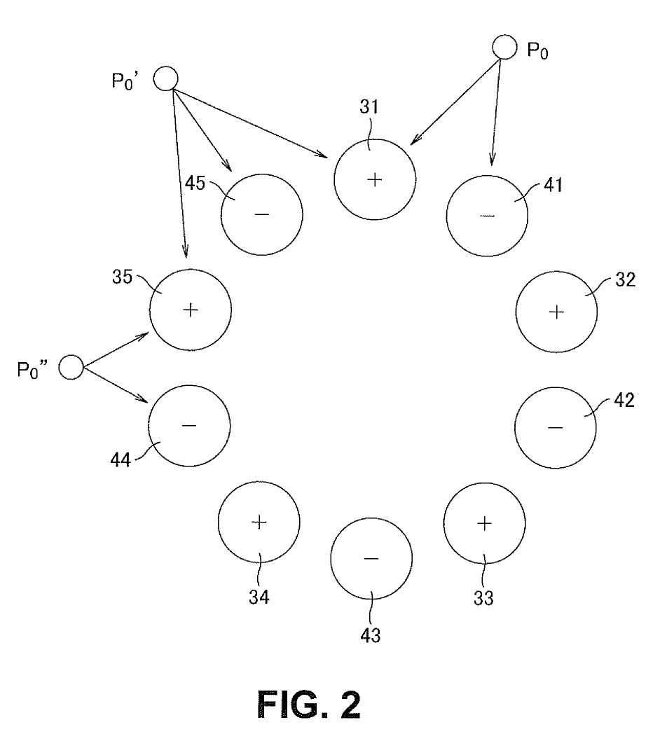

A second embodiment will be described below with reference to FIG. 2. In FIG. 2, reference numerals 31, 32, 33, 34, and 35 represent first group of microphone units, and reference numerals 41, 42, 43, 44, and 45 represent second group of microphone units. The direction orthogonal to the drawing is parallel to the directional axes of the microphone units. The microphone units are arranged on a circle at equal intervals, and the directional axes are parallel to each other. The diaphragms of the microphone units are disposed parallel to the drawing and on a single plane. The microphone units according to this embodiment are also condenser microphone units. The microphone units 31 to 35 in the first group and the microphone units 41 to 45 in the second group are disposed alternately on the circle.

The microphone units include impedance converters (not shown) impedance-converting audio signals that are electroacoustically converted by the microphone units. The microphone units 31 to 35 in the first group are connected in series such that the signals from the microphone units 31 to 35 are added and output. Specifically, the five microphone units are connected in series such that, for example, the output from the impedance converter of one of the microphone units drives the ground side of the condenser microphone capsule in the next microphone unit. Finally, a balanced output signal is output from the hot terminal via the impedance converter of the fifth microphone unit.

Similarly, the microphone units 41 to 45 in the second group are connected in series such that the output signals of the microphone units 41 to 45 are added and output. However, the five microphone units 41 to 45 in the second group are connected in series via the impedance converters such that the phase of the outputs from the microphone units 41 to 45 is reversed to the phase of the outputs from the microphone units 31 to 35 in the first group. Finally, balanced output signals are output from the cold terminal via the impedance converter of the fifth microphone unit.

In FIG. 2, reference characters Po, Po′, and Po″ represent sound sources. As described above with reference to FIG. 1, the microphone units 31 to 35 in the first group and the microphone units 41 to 45 in the second group are disposed alternately. This arrangement decreases the difference between the average time required for sound waves to reach the first group of microphone units and the average time required for sound waves to reach the second group of microphone units. Thus, the difference in sound quality between the signal output from the hot terminal, which is the sum of the outputs of the five microphone units 31 to 35 in the first group, and the signal output from the cold terminal, which is the sum of the outputs of the five microphone units 41 to 45 in the second group, can be decreased.

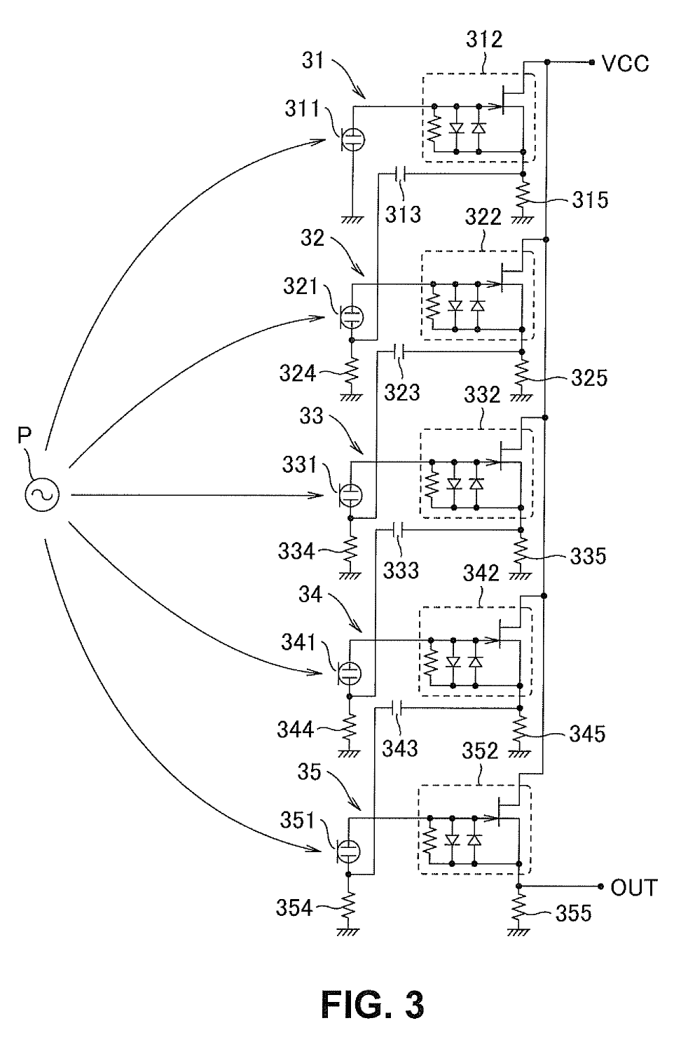

FIG. 3 illustrates a typical connection of microphone units according to the present invention. Specifically, FIG. 3 illustrates the microphone units 31 to 35 in the first group according to the second embodiment, which is illustrated in FIG. 2. The microphone units 31 to 35, respectively, include condenser microphone capsules 311 to 351 and impedance converters 312 to 352. Each of the microphone capsules 311 to 351 has a diaphragm and a fixed electrode opposing the diaphragm. The impedance converters 312 to 352 are auto-biased and each has a FET, which is an active element. The drains of the FETs of the impedance converters 312 to 352 receive a voltage VCC from a direct voltage source. The sources of the FETs are connected to a ground via resistors 315 to 355, respectively. Output signals from the microphone units are output from the sources of the corresponding FETs.

The diaphragms and fixed electrodes in the microphone capsules 311 to 351 are connected to a ground at one terminal. The microphone capsule 311 is directly grounded at its ground terminal, but the microphone capsules 321 to 351 are grounded via resistors 324 to 354, respectively at their ground terminals. Output signals from the microphone unit 31 are sent to the ground terminal of the microphone capsule 321 of the microphone unit 32 via a capacitor 313; output signals from the microphone unit 32 are sent to the ground terminal of the microphone capsule 331 of the microphone unit 33 via a capacitor 323; output signals from the microphone unit 33 are sent to the ground terminal of the microphone capsule 341 of the microphone unit 34 via a capacitor 333; and output signals from the microphone unit 34 are sent to the ground terminal of the microphone capsule 351 of the microphone unit 35 via a capacitor 343. The microphone units are connected in series such that the output signals from the five microphone units 31 to 35 are added and output from the source of the FET in the impedance converter 352 of the microphone unit 35. The added output signals are output from, for example, the hot terminal as a balanced output signal.

FIG. 3 illustrates only the connection of the five microphone units in one of the groups. The five microphone units in the other group are also connected in series in a similar manner. However, in order to output a signal from the five microphone units in the other group as a balanced output signal from the cold terminal, the phase of the signal is reversed to the phase of signals output from the hot terminal. In FIG. 3, a reference character P represents a sound source.

The circuitry illustrated in FIG. 3 includes five microphone units in a group. However, if there are only two microphone units in a group, as in the embodiment illustrated in FIG. 1, the output of one of the microphone units drives the ground side of the condenser microphone capsule in the other microphone unit.

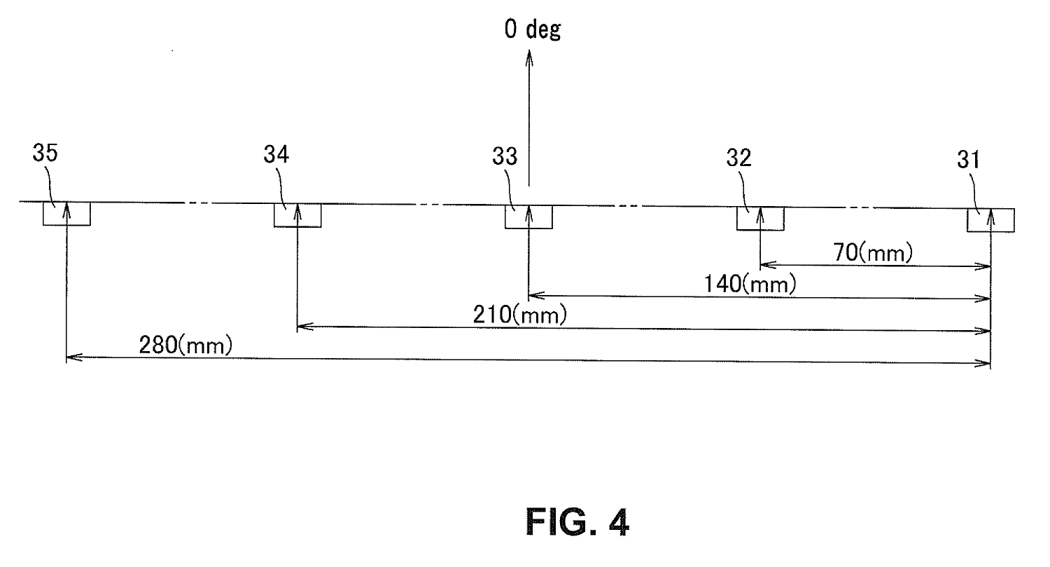

FIG. 4 illustrates the positional relationship among the five microphone units 31 to 35. The diaphragms in the microphone units 31 to 35 reside on a single plane, which is orthogonal to the drawing and is represented by the two-dot chain line in FIG. 4. Hence, the sound collecting axes of the microphone units 31 to 35 extend in the vertical direction in FIG. 4 and are parallel to each other. The microphone units 31 to 35 have equal intervals of 70 mm. Each of the microphone units of the other group is disposed between two adjacent ones of the microphone units 31 to 35.

In FIG. 4, the microphone units are arranged linearly. The arrangement is not limited thereto. Alternatively, four microphone units may be disposed on a square, as illustrated in FIG. 1, or a plurality of microphone units may be disposed on a circle, as illustrated in FIG. 2.

The design may be modified as desired within the scope of the technical concept recited in claims.

What is claimed is:

1. A microphone comprising:
a plurality of microphone units; wherein
the microphone units include a first group of microphone units and a second group of microphone units,
the first group of microphone units and the second group of microphone units are disposed alternately,
the first group of microphone units are connected in series such that outputs from the first group of microphone units are added and outputted as an added output,
the second group of microphone units are connected in series such that outputs from the second group of microphone units are added and outputted as another added output, and
the added output of one of the first group of microphone units and the second group of microphone units is output from a hot terminal as a balanced output and the other added output is output from a cold terminal as a balanced output.

2. The microphone according to claim 1, wherein
the microphone units each include a diaphragm vibrating in response to received sound waves, and
the diaphragms are disposed on a single plane.

3. The microphone according to claim 1, wherein
the microphone units comprises four microphone units,
the first group of microphone units are disposed at diagonal positions in view along sound collecting axes of the microphone units, and
the second group of microphone units are disposed at diagonal positions in view along the sound collecting axes of the microphone units.

4. The microphone according to claim 2, wherein
the microphone units comprises four microphone units,
the first group of microphone units are disposed at diagonal positions in view along sound collecting axes of the microphone units, and
the second group of microphone units are disposed at diagonal positions in view along the sound collecting axes of the microphone units.

5. The microphone according to claim 1, wherein
the microphone units are disposed on a circle at equal intervals, and
the first group of microphone units and the second group of microphone units are disposed alternately on the circle.

6. The microphone according to claim 2, wherein
the microphone units are disposed on a circle at equal intervals, and
the first group of microphone units and the second group of microphone units are disposed alternately on the circle.

7. The microphone according to claim 1, wherein
the microphone units comprise condenser microphone units each including
a condenser microphone capsule having
a diaphragm vibrating in response to received sound waves and
a fixed electrode opposing the diaphragm, and
an impedance converter performing impedance conversion on a signal electroacoustically converted at the condenser microphone capsule and output.

8. The microphone according to claim 2, wherein
the microphone units comprise condenser microphone units each including
a condenser microphone capsule having
the diaphragm and
a fixed electrode opposing the diaphragm, and
an impedance converter performing impedance conversion on a signal electroacoustically converted at the condenser microphone capsule and output.

9. The microphone according to claim 3, wherein
the microphone units comprise condenser microphone units each including
a condenser microphone capsule having
a diaphragm vibrating in response to received sound waves and
a fixed electrode opposing the diaphragm, and
an impedance converter performing impedance conversion on a signal electroacoustically converted at the condenser microphone capsule and output.

10. The microphone according to claim 4, wherein
the microphone units comprise condenser microphone units each including
a condenser microphone capsule having
the diaphragm and
a fixed electrode opposing the diaphragm, and
an impedance converter performing impedance conversion on a signal electroacoustically converted at the condenser microphone capsule and output.

11. The microphone according to claim 5, wherein
the microphone units comprise condenser microphone units each including
a condenser microphone capsule having
a diaphragm vibrating in response to received sound waves and
a fixed electrode opposing the diaphragm, and
an impedance converter performing impedance conversion on a signal electroacoustically converted at the condenser microphone capsule and output.

12. The microphone according to claim 6, wherein
the microphone units comprise condenser microphone units each including
a condenser microphone capsule having
the diaphragm and
a fixed electrode opposing the diaphragm, and
an impedance converter performing impedance conversion on a signal electroacoustically converted at the condenser microphone capsule and output.

13. The microphone according to claim 8, wherein
the first group of microphone units are connected in series and the second group of microphone units are connected in series such that, in each group, an output from the impedance converter of one of the condenser microphone units drives a ground side of the condenser microphone capsule of another condenser microphone unit.

14. The microphone according to claim 9, wherein
the first group of microphone units are connected in series and the second group of microphone units are connected in series such that, in each group, an output from the impedance converter of one of the condenser microphone units drives a ground side of the condenser microphone capsule of another condenser microphone unit.

15. The microphone according to claim 11, wherein
the first group of microphone units are connected in series and the second group of microphone units are connected in series such that, in each group, an output from the impedance converter of one of the condenser microphone units drives a ground side of the condenser microphone capsule of another condenser microphone unit.
